(19) United States
(12) Patent Application Publication
(10) Pub. No.: US 2018/0235352 A1
(43) Pub. Date: Aug. 23, 2018

(54) Multi purpose personal transport gear that converts from backpack to comfort pad to poncho to hammock

(71) Applicants: Janay Jones, Nashville, TN (US); Jake Evans, Charlotte, NC (US)

(72) Inventors: Janay Jones, Nashville, TN (US); Jake Evans, Charlotte, NC (US)

(21) Appl. No.: 15/441,221

(22) Filed: Feb. 23, 2017

(51) Int. Cl. A45F 4/02; A45F 3/04; A45F 4/04; A45F 4/08; A45F 3/22; A45F 4/12; A45F 4/06; A41D 3/08; A41D 27/02; A47D 13/06; A47C 4/30; A47C 1/14; E04H 15/32; B62J 9/00; E03B 3/02; B67C 11/02

(52) U.S. Cl. CPC A45F 4/02; A41D 2400/10; A45F 4/04; A45F 4/08; A45F 3/22; A45F 4/12; A45F 4/06; A41D 3/08; A41D 27/02; A47D 13/063; A47D 13/066; A47C 4/30; A47C 1/14; E04H 15/32; B62J 9/00; E03B 3/02; B67C 11/02; A45F 2004/026; A41D 2200/20; A45F 3/04

(57) ABSTRACT

A convertible backpack system and method for conversion between a backpack, to comfort pad, to poncho, to water collection device, to a blind, to a tent, to a hammock, to a seat, to a playpen or storage container, and to an office pack.

Application requests the benefit of the filing date of prior provisional application No. 62/304,030 filed on Feb. 23, 2016.

### BACKGROUND OF THE INVENTION

### I. Field of the Invention

The present invention relates generally to the field of backpacks and more particularly to a folding backpack apparatus for conversion between a backpack and mattress/mattress pad/blanket, a poncho and other arrangements.

### II. Description of the Related Art

Present backpacks are utilized for various forms of storage for transport, typically for hiking, camping, picnicking, attending entertainment events, and the like. When camping or attending an event, in particular, it is desirable to have some sort of barrier between the user and the ground, the user often transports a blanket, mattress pad or other suitable barrier. These barriers can occupy a significant amount of space in the backpack, thereby leaving little or no room for other items, and often requiring the user to bring other bags with him/her. Furthermore, the user must typically formulate a folding pattern by trial and error, in an attempt to minimize the volume of space the barrier occupies.

Therefore, there persists a problem with present backpacks having limited space for the storage of blankets, mattress pads and other barriers in addition to other items for storage within the backpacks.

Furthermore, and along the same line of understanding, once a large barrier is available it is useful for more than as a comfort pad, to replace many other items that may be needed for outdoor activities. Prior art solutions include framework and coverings that accommodate one another in a specific assembly. As such, a user must carry the specific assemblies, further increasing the load on the outdoor user. In the alternative, a user can be resourceful and use the barrier for the purposes needed. For example, the user can hold the barrier above his head to protect from rain. This prior art solution is not as effective as if the barrier had details and structure to facilitate the use as a poncho.

III. The invention disclosed herein is designed to increase the efficiency and convenience for outdoor users. Outdoor user activities include but are not limited to camping, picnicking, backpacking, napping, hunting, fishing, bow hunting, hiking and attending outdoor events.

### SUMMARY

The present invention is a “versatile apparatus” having the capacity to be useful in many embodiments by including the appropriate structure, details and methods. The most fundamental conversion of the versatile apparatus from one arrangement to the next is from the backpack to the comfort pad. Additional arrangements are presented as embodiments.

In general, the invention first features a folding backpack apparatus for conversion between a backpack and a comfort pad. It is appreciated that the comfort pad can include blankets, pads, mattress pads or any other planar material that a user can sit, lie or otherwise physically occupy, for comfort, sleeping and the like. The invention further features a method of converting the backpack to and from the comfort pad, generally including a pre-set folding pattern. The apparatus includes a main body having a hollow interior, shoulder straps and side flaps for generally retaining the main body in a back pack form. The main body generally includes a front flap and a rear flap that are maintained by an upper and lower strap set. The strap sets and the side flaps can be opened and the main body folded outwards into a comfort pad.

In general, in one aspect, the invention features a backpack apparatus for conversion into comfort pad, including a main body having a hollow interior, and having a front flap and a rear flap contiguously connected to one another through a bottom portion, wherein the main body also has an upper strap set connected to the rear flap and coupled to a lower strap set connected to the front flap. Shoulder are straps connected to an upper end and a lower end of the rear flap and side flaps connected to a fixed connection point on the front flap and a removable connection point on the rear flap.

In one implementation, the apparatus further includes a short front flap and a short rear flap wherein the short front flap is connected to the front flap and folded into the hollow interior. The short rear flap is connected to the rear flap, and is positioned in opposition to the short front flap and folded. In another implementation, the front flap and the rear flap form two elongate folded-over portions when separated from one another.

In another implementation, each of the folded-over portions has a width.

In another implementation, the folded-over portions each fold out to a half comfort pad four times the width. In another implementation, each of the elongate folded-over portions is folded over in quarter folds. In another implementation, the elongate folded-over portions are separated by a longitudinal axis. In another implementation, the front and rear flaps unfold into a planar comfort pad.

In another aspect, the invention features a comfort pad apparatus for conversion into a backpack, wherein the comfort pad apparatus includes a planar pad having an upper surface and a lower surface and generally separated by a longitudinal axis. Shoulder straps are connected to the lower surface, straddling the longitudinal axis, and an upper strap set connected to the lower surface, straddling the longitudinal axis above the shoulder straps. A lower strap set is connected to the lower surface, straddling the longitudinal axis below the shoulder straps and for connecting to the upper strap set and a set of side flaps, wherein the upper strap set and the set of side flaps are each connected to the lower surface at the longitudinal axis.

In one implementation, the upper surface includes a fleece lining. In another implementation, the apparatus can include other surfaces having insulation properties. In another implementation, the apparatus can include other surfaces having water resistant or water proof properties. In still another implementation, the apparatus can have other surfaces having anti-reflective or anti-ultraviolet radiation properties.

In another aspect, the invention features a method for converting between a backpack and a comfort pad, including separating a front flap and rear flap of the backpack so that the front and rear flaps are laying on a surface, thereby forming elongate portions that are in a first open position, the elongate portions generally being separate by a longitudinal axis into a width, unfolding a short front flap and a short rear flap away from each other, both along the longitudinal axis, the elongate portions being in a second open position, unfolding the elongate portions away from the longitudinal axis, the elongate portions being in a third open position, unfolding the elongate portions away from the longitudinal axis, the elongate portions being in a fourth open position, thereby fully opening an upper surface of the comfort pad.

In another aspect, the invention features a method for converting between a comfort pad and a backpack, including folding a first elongate portion of the comfort pad into half of its width toward a longitudinal axis separating the first elongate portion and a second elongate portion, folding the second elongate portion into half of its width toward the longitudinal axis, folding the first and second elongate portions into half their widths, toward the longitudinal axis, folding opposing ends of the elongate portions to short front and rear flaps along the longitudinal axis and folding over the comfort pad into generally half its length along the longitudinal axis, thereby forming the front and rear flaps of the backpack.

In one implementation, the method further includes folding over side flaps, wherein the side flaps are connected to an outer surface of the front flap to connection points on the rear flap. In another implementation, the method further includes bucking together upper and lower strap sets, wherein the upper strap set is connected to the rear flap and wherein the lower strap set being connected to the front flap. In another implementation, the strap can pass through the front flap. In another aspect, the invention features a back pack and comfort pad combination, including a main body having shoulder straps and means for converting the main body from a planar comfort pad having an upper surface and a lower surface into a back pack having a front and rear flap, bottom portion and side flaps.

In one implementation, the combination further comprises a means for retaining the main body in the form of the back pack. In another implementation, the combination further comprises an upper and lower strap set for opening and closing a front flap of the back pack. In another implementation, the upper strap set is connected to a rear flap of the main body. In another implementation, the lower strap set is connected to the front flap and passing through from rear of the front flap to front of the front flap at a distance below top of the front flap. In another implementation, the combination further includes side flaps for retaining the main body in the form of the back pack.

Once the apparatus is available as a backpack and convertible to a comfort pad, the apparatus is capable of additional arrangements because additional structures and details are incorporated into the apparatus. Structure is meant to convey additional hardware that is used to form framing, facilitate securing, and is generally separate from the base arrangement. Details are integrated into the base arrangement, and make the base arrangement of a pack or comfort pad unique and distinguishable from prior art solutions.

In general, the apparatus has one arrangement as a pad. This is also referenced as a mat, having an inner and an outer liner.

In an embodiment, the apparatus is a poncho. Nonlimiting structure and details are suggested here. The apparatus has incorporated a hood as a detail that is folded flat and can be concealed as a using a zipper or other means. The hood is made to fold flat and incorporate into the interior of the backpack arrangements. The hood further is sized to fit an adult head and includes an integrated string to cinch, or secure the hood to the user. Furthermore, the details include connectors such as snaps to form a sleeve area for a user's arms, and having a waterproof or water resistant exterior fabric, and further having an insulating lining for the interior surface.

In an embodiment, the apparatus is useful as a portable hunting blind. Nonlimiting structure and details are suggested here. Details include attachment points and rope or straps for attachment to trees. Details include precisely located, reinforced rings or connectors to allow for attachment using included structures such as rope or straps.

In an embodiment, the apparatus is a tent. Nonlimiting structure and details are suggested here. The structure includes the pad, having a resilient outer and personable inner. The structure further includes detachable, collapsible and flexible rods that, when collapsed, fit inside the device when it is in backpack form; and when assembled the rods create a tent frame. Rods can include bungee cord that runs through the inside of the flexible rods and more facilitate rapid assembly. In a first embodiment, the pad is placed on top of the tent frame. Details include at least one securing means to attach the pad to the frame, and these details are a part of the pad. Details include connection capability such as snaps or zippers to enclose the tent on either end. Connection details include any of a variety of fastening devices common to the art.

Securing means and details are used throughout this description and include snaps, zippers, Velcro or others common to the art and are integrated into the resilient outer. These are useful for securing the inner to the outer, allowing the inner to be separable and used as a blanket, for example. Other attachment means allow the outer pad to be secured to frames and other structure. These attachment means include but are not limited to reinforced clearance holes, reinforced belt loop attachments, zippers, Velcro or similar, snaps, ropes, bungee cords, short tie straps and bolt/nut assemblies for more permanent uses of the various arrangements, or other means of attachment common within the art.

In a second tent arrangement, the frame is removed from the backpack, assembled, and then inserted between the inner and outer layers of the comfort pad. This is a rapid assembly option.

Further regarding the tent arrangement of the claimed invention, details include the use of the inner liner as a floor or covering. Nonlimiting structure and details are suggested here. Details include connection capability for a second complete apparatus to provide a floor for the tent, and a larger tent. Details include versatile interconnectivity of the flexible rods for use as tent upper structure of floor. Details include versatile connection capability to attach the floor apparatus to the tent apparatus. Details include snaps, zippers, Velcro or other attachment to allow removal of the liner for use as a blanket.

In an embodiment, the apparatus is useful as a crib or playpen. Nonlimiting structure and details are suggested here. Structure can include foldable or collapsible rods for the frame. Structure also includes foldable legs and ground standoffs to at least raise the edges of the apparatus off the ground. Structure includes netting that attaches to the frame and pad for security and for bug defense. Structure includes a foldable top shade that can attach to the frame, or the other structural elements herein disclosed.

In an embodiment, the apparatus converts to a hammock or seat. Nonlimiting structure and details are suggested here. Details include precisely located attachment points. Structure includes rope or straps. Structure includes collapsible rods and/or larger rod structures to add rigidity to the entire assembly, specifically for use as a hammock or as a seat. The details include quick connection details for the ropes or straps. Details include precisely located pockets to accommodate the rods. Furthermore, the apparatus has details that are used to suspend a chair arrangement without using the framework.

In an embodiment, the waterproof liner includes rain capture details that use the apparatus to collect water in a bottle when the apparatus is used as a poncho. Nonlimiting structure and details are suggested here. Structure includes bottle retention details at key locations. Detail and structure can also include shaping at least one edge of the apparatus to more effectively collect water and drain it toward the retained bottle. Details include a snap-type connector to form a sculpted edge into a funnel. Additional structure includes collapsible framing to prop up the apparatus to collect water when the apparatus is not being worn.

In an embodiment, the apparatus is an office pack or city bag. In an embodiment, the apparatus has capability to receive at least two inserted sections that are removably attached. Sections can include a clothing bag and a shoe bag. Alternately, another possibility is the shoe bag with a computer housing. Other options are considered as nonlimiting examples. Nonlimiting structure and details are suggested here. Structure includes removable attachments such as at least one zipper, Velcro seam, snap seam and the like. Details include at least two mating details to secure the inserts to the pack. Structure includes a sleeve into which clothes are inserted and a rod/unique hanger on which to hang pants and support a shirt and jacket. The rod can have attachment details to secure it to the inside of the pack.

In an embodiment, the apparatus is sized to accommodate standard briefcase and computer bag sizes. In an embodiment, a briefcase or computer bag is included. In an embodiment, the apparatus is sized to also accommodate a fabric bag housing shoes.

In an embodiment, external details include versatile carry straps that function as closures and as attachment points for a longer strap. Nonlimiting structure and details are suggested here. This allows the apparatus to be transported in alternative ways, such as attached to a motorcycle, bike rack, luggage rack, bicycle and similar. The details necessary include additional strapping with connectors. Details also include structure such as rods and rigid planes to assist apparatus in keeping its shape and form.

In an embodiment, the apparatus is useful as a professional garment bag. Nonlimiting structure and details are suggested here. Structure includes fabric bags to accommodate shoes with delicate surfaces. Structure can include boxes to contain other items such as belts, means to secure jewelry cards and valuables such as Velcro attached wallets or more resilient, durable attachment details for security. Details include items such as Velcro to secure a box, snaps inside the pack arrangement and integrated with the pad with which a garment holder can attach. A garment holder is contemplated similar to a hanger, but with details to cover it with a bag and secure it into the pack.

In an embodiment, additional light Mylar layer is included. The Mylar layer can cover at least a portion of the unfolded apparatus. The Mylar layer can be included as a separate structure. In an embodiment, the Mylar layer is attached on at least one side to the unfolded apparatus using snaps, clips, Velcro or similar. The Mylar layer is used with the frame structures disclosed in this embodiment to provide a lightweight alternative to using the apparatus as an outer shell. Thus allowing the apparatus to be used separate from the alternate structures.

In an embodiment, at least two apparati can be connected together to form a larger assembly. Such an assembly will serve as a larger pad, perhaps the result of a couple having two apparati and using them both in conjunction. As an example, such an option also allows for two small tents to be connected, two playpen embodiments to be attached, two hammocks or seats to be connected and two blinds installed to form a larger entity. Structure includes reinforcements and connectors. Details include connectors alternately disposed along at least one edge of each apparatus. Details include specific placement of connectors so that the connected apparati are aligned and oriented appropriately.

One feature and advantage of the invention is that it provides a comfort pad as well as suitable storage space for items. Another feature and advantage of the invention is that it provides a pre-set folding pattern thereby requiring little mental effort from the user to remember how to fold the comfort pad. Another feature and advantage of the invention is that is provides a comfort pad providing comfort to the user and protection from natural elements.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing FIG. s, in which like reference numerals denote similar structure and refer to like elements throughout, and in which:

FIG. 1 illustrates a front perspective view of an embodiment of a folding backpack apparatus in a closed position;

FIG. 2 illustrates a rear perspective view of an embodiment of a folding backpack apparatus in a closed position;

FIG. 3 illustrates a top plan view of an embodiment of a folding backpack apparatus in a closed position;

FIG. 4 illustrates a top plan view of an embodiment of comfort pad apparatus formed from an embodiment of a folding backpack apparatus in a first open position;

FIG. 5 illustrates a top plan view of an embodiment of a comfort pad apparatus formed from an embodiment of a folding backpack apparatus in a second open position;

FIG. 6 illustrates a top plan view of an embodiment of a comfort pad apparatus formed from an embodiment of a folding backpack apparatus in a third open position;

FIG. 7 illustrates a top plan view of an embodiment of a comfort pad apparatus formed from an embodiment of a folding backpack apparatus in a fourth open position;

FIG. 8 illustrates a bottom plan view of an embodiment of a comfort pad apparatus formed from an embodiment of a folding backpack apparatus in a fourth open position; and

FIG. 9 illustrates a side view of an embodiment of a folding backpack apparatus in a closed orientation.

FIG. 10 illustrates details and structure to accommodate a frameless chair arrangement.

FIG. 11 illustrates details and structure to accommodate a hammock arrangement.

FIG. 12 illustrates details and structure to accommodate a framed chair arrangement.

FIG. 13 Illustrates details and structure to accommodate a playpen or storage arrangement.

FIG. 14 Illustrates details and structure to accommodate a water collection arrangement.

### DETAILED DESCRIPTION

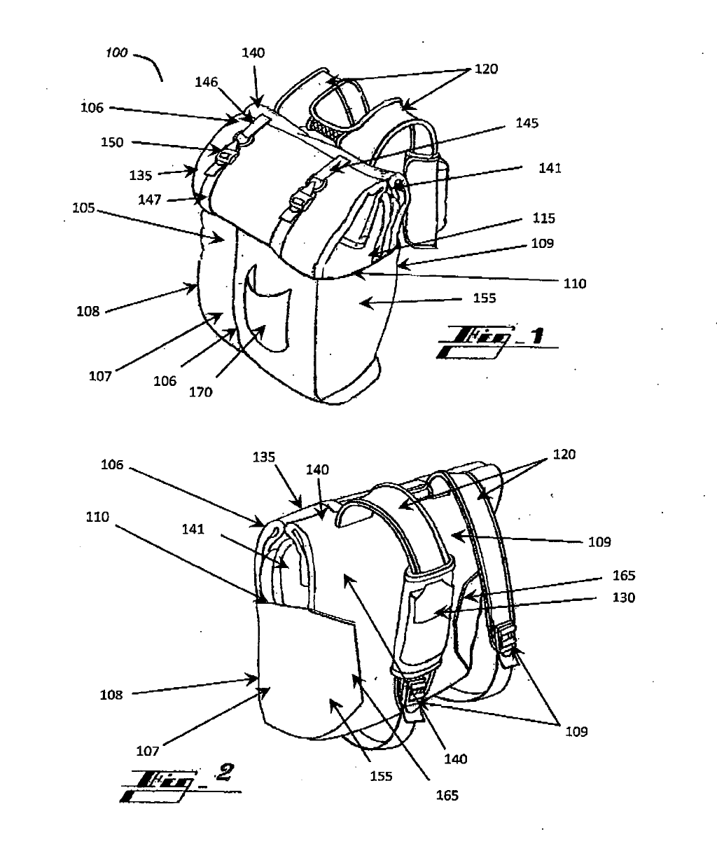

In describing the preferred and selected alternate embodiments of the present invention, as illustrated in FIGS. 1-12, specific terminology is employed for the sake of clarity. The invention, however, is not intended to be limited to the specific terminology so selected, and it is to be understood that each specific element includes all technical equivalents that operate in a similar manner to accomplish similar functions.

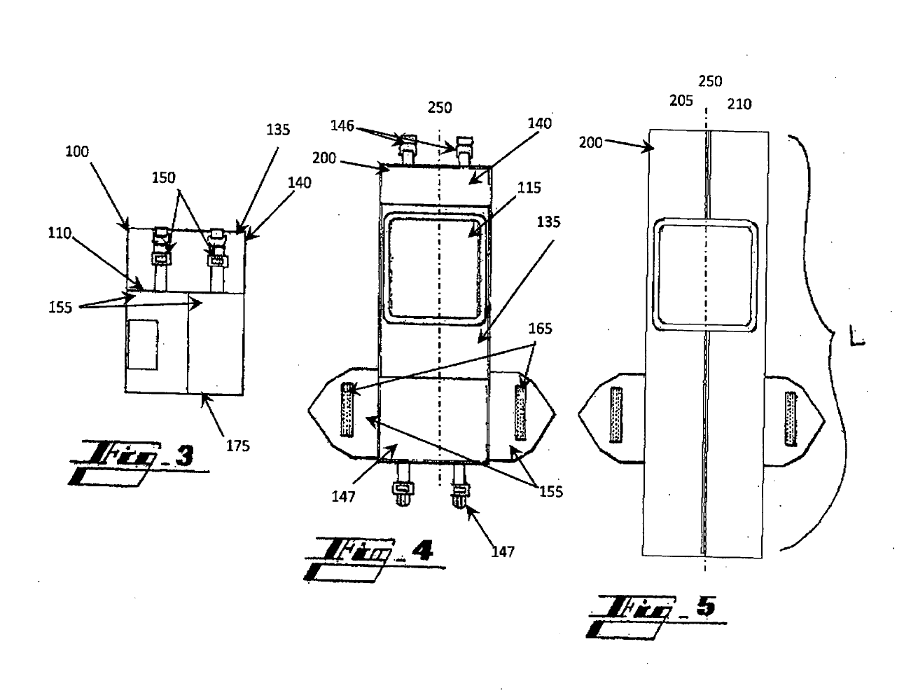

Referring to the drawings wherein like reference numerals designate corresponding parts throughout the several figures, reference is made first to FIG. 1 that illustrates a front perspective view of an embodiment of a folding backpack apparatus 100 in a closed position. FIG. 2 illustrates a rear perspective view of an embodiment of a folding backpack apparatus 100 in a closed position. In general, the apparatus includes a main body 105 having a hollow interior 110 defined therein. The main body 105 generally includes an upper end 106, a lower end 107, a front side 108 and a rear side 109. The hollow interior 110 can include any variety of contents such as pillow 115 as shown in FIG. 1. Shoulder straps 120 are connected between the upper and lower ends 106, 107 generally adjacent the rear side 109. Shoulder straps 120 can advantageously be adjustable via buckles 125. The shoulder straps can further include pads and pockets 130.

The apparatus 100 can further include front flap 135 and rear flap 140, wherein front flap 135 and rear flap 140 are generally held in a closed position by straps 145, each strap 145 having upper strap 146 connected to the upper end 106 at rear flap 140, and a lower strap 147 generally connected to a lower portion of front flap 135. The upper and lower straps 146, 147 are connected together through buckles 150. In a typical implementation, the buckles 150 can be used to connect and disconnect the upper and lower straps 146, 147 from one another so that the front and rear flaps 135, 140 can be opened and closed to access the hollow interior 110. The front flap 135 generally further includes front short flap 136, and the rear flap 140 includes rear short flap 141. The front and rear short flaps 136, 141 can be advantageously folded in a variety of ways, which includes, but is not limited to as shown in the Figures.

The apparatus 100 further includes side flaps 155 that are generally connected to front flap 135 at a common connection point 160 and wrap around the main body 105 to respective connection points 165 on rear flap 140. In a typical embodiment, the rear connection points 165 are hook and loop fasteners such that the side flaps 155 can be connected and disconnected from the rear flap 140 as discussed further in the description below. The side flaps 155 as well as various other locations along the main body 105 can include additional storage pockets 170 as needed.

FIG. 3 illustrates a top plan view of an embodiment of a folding backpack apparatus 100 in a closed position. As is appreciated further in the description below, the front and rear flaps 135, 140 are contiguously connected such that a bottom 175 of the apparatus 100 is formed from the contiguous connection. The side flaps 155 function as the side walls of the apparatus 100 and the front and rear flaps 135, 140 function as the front and rear walls of the apparatus thereby forming the self-contained hollow interior 110.

The backpack apparatus 100 can advantageously be converted into a comfort pad apparatus 200 (see FIGS. 3-8) by opening buckles 150 to generally separate front and rear flaps 135, 140, and by detaching side flaps 155 from the connection points 165 on rear flap 140. By opening buckles 150 and detaching side flaps 155, the front and rear flaps 135, 140 are entirely open thereby generally dismantling the backpack apparatus 100 and transforming the backpack apparatus 100 into the comfort pad apparatus 200. The details of the transforpadion and conversion from the backpack apparatus 100 to the comfort pad apparatus 200 are now described.

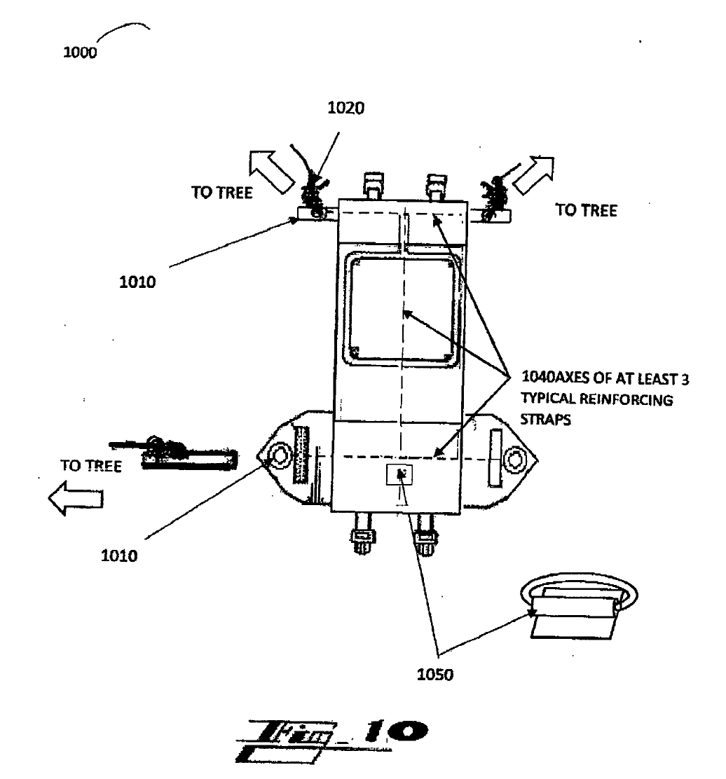

FIG. 4 illustrates a top plan view of an embodiment of a comfort pad apparatus 200 formed from an embodiment of a folding backpack apparatus 100 in a first open position. In a typical implementation, the front and rear flaps 135, 140 have been folded from one another so that they are oriented 180.degree. with respect to one another and wherein front and rear flaps 135, 140 lay flat on a surface, such as the ground. Side flaps 155 can be advantageously laid open on the surface generally perpendicular to the front and rear flaps 135, 140. When the front flap 135 is first unfolded, the front short flap 136 remains in the inward folded position as described above. Similarly, when the rear flap 140 is first unfolded, the rear short flap 141 remains in the inward folded position as described above. It is understood that the flaps, such as rear flap 140, can be folded in a variety of ways. The orientation in FIG. 4 and all the Figures is for illustrative purposes only. The upper and lower straps 146, 147 remain partially exposed. The shoulder straps 120 have advantageously been fully covered in this first open position. The contents 115 are shown as a pillow 115 is shown for illustrative purposes. In general, the comfort pad apparatus 200 is arranged about an axis 250 toward which and away from the folding and folding generally occurs as described further below.

FIG. 5 illustrates a top plan view of an embodiment of a comfort pad apparatus 200 formed from an embodiment of a folding backpack apparatus 100 in a second open position. In the second position the front and rear short flaps 136, 141 are further folded outwards along the axis 250, which advantageously cover the upper and lower straps 146, 147. When in this partially unfolded second position, the comfort pad apparatus 200 includes two elongate folded-over portions 205, 210 each having width w and length L.

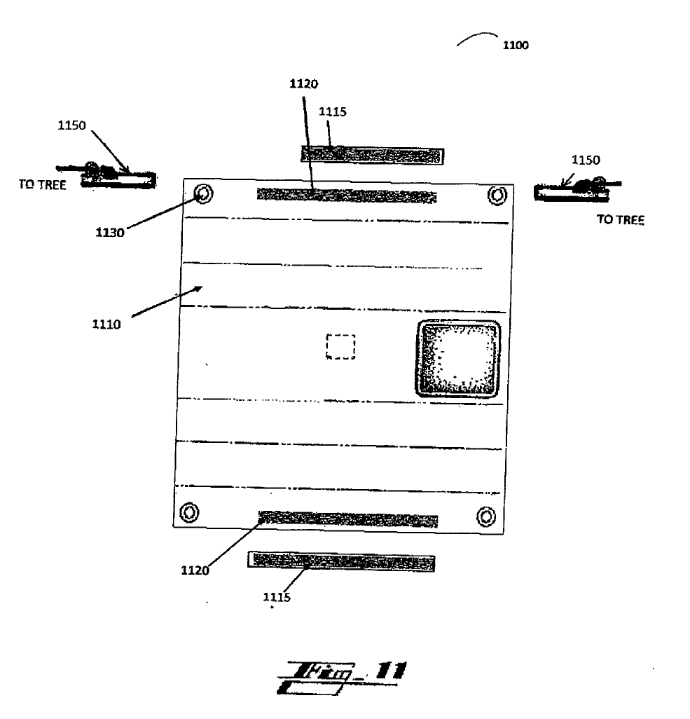

FIG. 6 illustrates a top plan view of an embodiment of a comfort pad apparatus 200 formed from an embodiment of a folding backpack apparatus 100 in a third open position. In this third open position, the elongate portions 205, 210 have further been unfolded away from the axis 250 to folded-over portions 205, 210 now each having width 2 w, or generally twice their original width, thereby increasing the width of the comfort pad apparatus 200 by a factor of two. The side flaps 155 are further covered by the unfolding of the folded-over portions 205, 210. One or both of the folded-over portions 205, 210 can include additional pockets 215 and straps 220.

FIG. 7 illustrates a top plan view of an embodiment of a comfort pad apparatus 200 formed from an embodiment of a folding backpack apparatus 100 in a fourth open position. In this fourth open position, the folded-over portions 205, 210 have been further unfolded away from axis 250 to folded-over portions 205, 210, now each having a width 4 w, or generally twice the previous folded width 2 w, or four times the original width w. The comfort pad apparatus 200 is generally planar and generally rectangular or square. The contents 115, illustrated as a pillow, has advantageously been placed at a head position on the comfort pad apparatus 200 to illustrate that the comfort pad apparatus 200 can be used as a pad for lounging, sitting or otherwise lying down. In a typical embodiment, the upper surface 225 of the comfort pad apparatus 200 can be lined with a warm soft material such as fleece or other suitable material. The apparatus 200 can further include a border that can be raised in one implementation in order to prevent items from rolling off the surface 225.

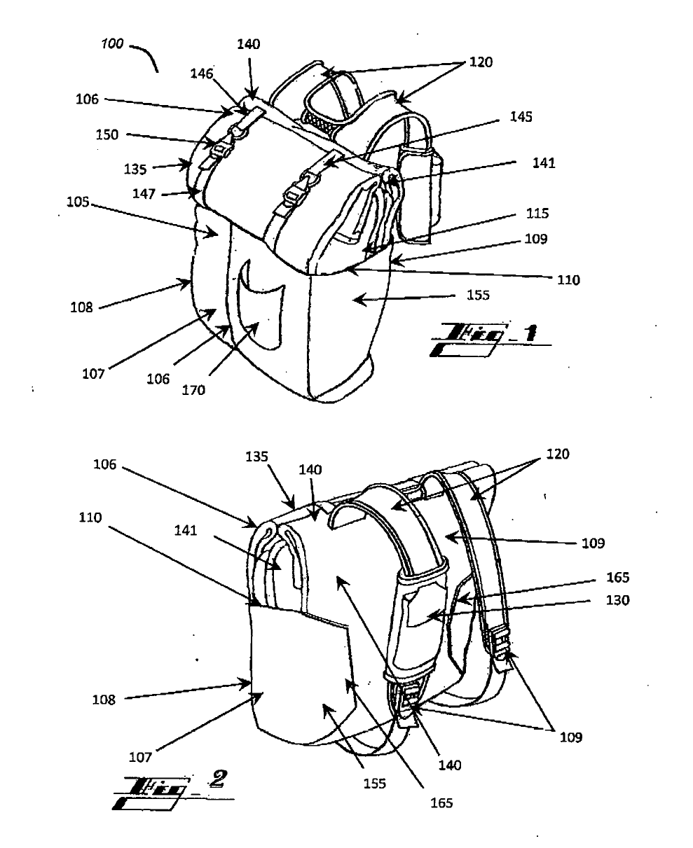

FIG. 8 illustrates a bottom plan view of an embodiment of a comfort pad apparatus 200 formed from an embodiment of a folding backpack apparatus 100 in a fifth open position. This bottom plan view illustrates that the components of the backpack apparatus 100, that is, the shoulder straps 120, the upper and lower straps 146, 147, the side flaps 155, pockets and pad 130, 170 and connection points 165, as well as pockets 215 and straps 220, are all located on the lower surface 235 of the comfort pad apparatus 200. In a typical embodiment, the lower surface 235 can be a durable weather resistant material such as vinyl or other suitable material. In still another implementation, an insulating layer (not shown) can be interposed between the upper and lower surfaces 225, 235 to provide further thermal insulation between the user atop the comfort pad apparatus 200 and the ground, to insulate the user from cold temperature.

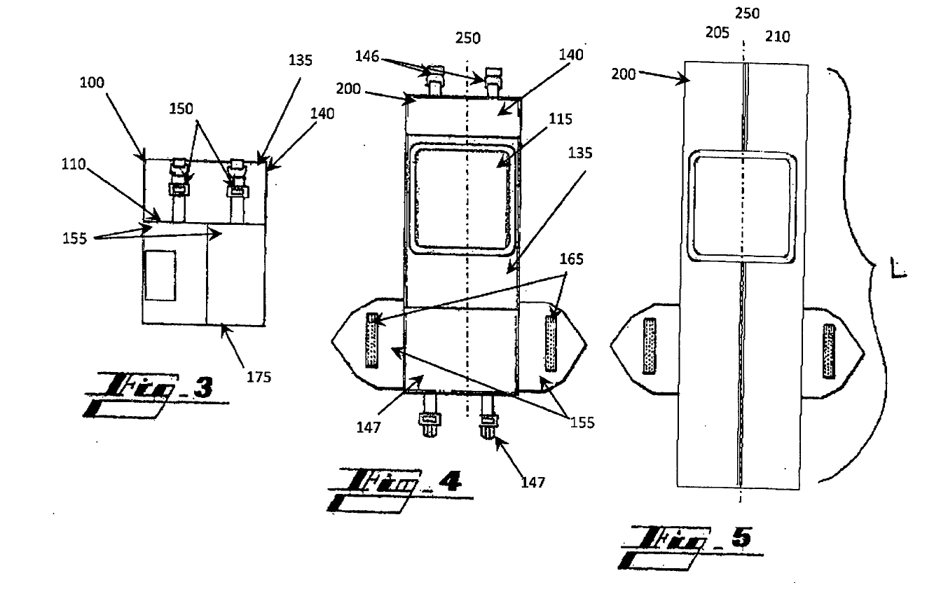

As indicated above, the comfort pad apparatus 200 can be converted into the backpack apparatus 100 generally by following the same steps in reverse. In general, in the fully unfolded or open position as illustrated in FIG. 7, the comfort pad apparatus 200 has overall length L and having a width 2 W, with two elongate portions 205, 210. The two elongate portions 205, 210 can be folded in half toward the axis 250 so that the folded-over elongate portions 205, 210 now each have width ½ W, as illustrated in FIG. 6. The folded-over portions 205, 210 can be further folded in half toward the axis 250 so that the folded-over portions 205, 210 now each have width ¼ W, as illustrated in FIG. 5, thereby exposing the side flaps 155. The front short flap 136 and the rear short flap 141 can both be partially folded over along the axis 250 as illustrated in FIG. 4, thereby exposing the upper and lower straps 146, 147. The backpack apparatus 100 can thus be assembled by folding the front and rear flaps 135, 140 about the bottom 175 and toward one another and connecting the side flaps 155 at the connection points 165. The upper and lower buckles 146, 147 can further be connected together to completely assemble and close the backpack apparatus 100 as illustrated in FIGS. 1-3 and in FIG. 9 that illustrates a side view of an embodiment of a folding backpack apparatus 100 in a closed orientation. It is therefore appreciated that the comfort pad apparatus 200 can be advantageously folded in a preset folding pattern thereby minimizing the volume that it occupies. Furthermore, the folded comfort pad apparatus 200 in its folded orientation forms the front and rear walls as well as bottom portion of the backpack apparatus 100.

FIG. 10 demonstrates a frameless chair arrangement. In this drawing, the pad is folded such that only the center section of the pad is visible. Detail 1010 shows an attachment point that is typical in 2 places. Here, 1010 is a fabric extension tab is shown and serves as an attachment point for 1020 anchor structure, 1020 is typical in 4 places. 1030 shows a reinforced ring, clearance hole that is typical in 2 places and serves as an attachment point for 1020 anchor structure. 1050 demonstrates a sewn in patch with an integrated tie down ring, this one anchor is used in various arrangements to receive a 1020 type of anchor structure (not shown). 1060 demonstrates three axes of at least 3 reinforcement bands or zones that can be extra fabric, or strengthening material that relieves the additional forces that will be experienced by the pad in a chair arrangement.

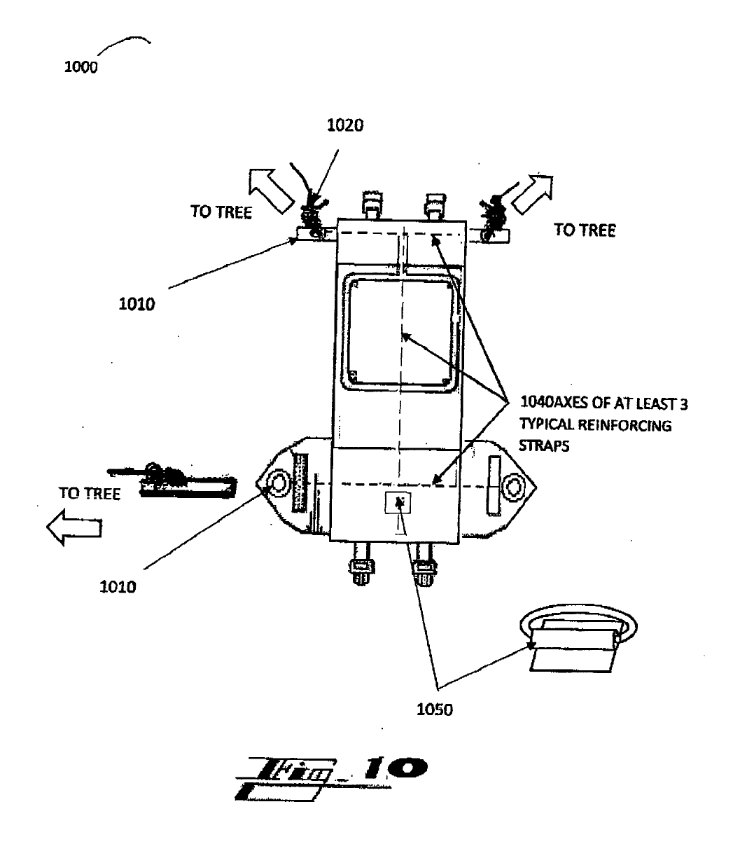

FIG. 11 demonstrates the mat with details and structure to accommodate a hammock arrangement. 1110 is the mat or comfort pad. 1120 demonstrates a structural insert that is typical in 2 places. The structural support secures to the 1110 pad using 1115 velcro strips, typical in 2 places. Note, this is also the detail used to attach one pad to another in other arrangements. The pad has one male Velcro strip along one end and one female Velcro strip along the opposite end. Other nonlimiting embodiments of this attachment include clearance holes, pins and rope. 1130 shows a reinforced ring, clearance hole that is typical in 4 places, each ring serves as an attachment point for 1150 anchor structure.

FIG. 12 demonstrates a framed chair arrangement. 1210 the backpack arrangement is shown to contain the folded, collapsed, chair frame. 1220 is an assembly view of a nonlimiting example of an expanded chair frame. Detail 1223 is a vertical support and pad attachment point, typical in 2 places. Detail 1226 is a lateral support and pad attachment point, typical in 2 places. 1230 demonstrates an embodiment of the expanded comfort pad. Detail 1260, typical in 2 places is a vertical pocket, secured to the pad with at least one open end through which 1223 pad attachments are inserted. Detail 1280, typical in 2 places is a lateral pocket, secured to the pad with at least one open end through which 1226 pad attachments are inserted. Detail 1240 is the ground anchor attachment point shown as detail 1050 in FIG. 10. 1250 is typical in 4 places and is shown as a clearance hole through which a rope or other attachment means is attached on one end, and the other end of the rope is attached to a vertical structure such as a tree.

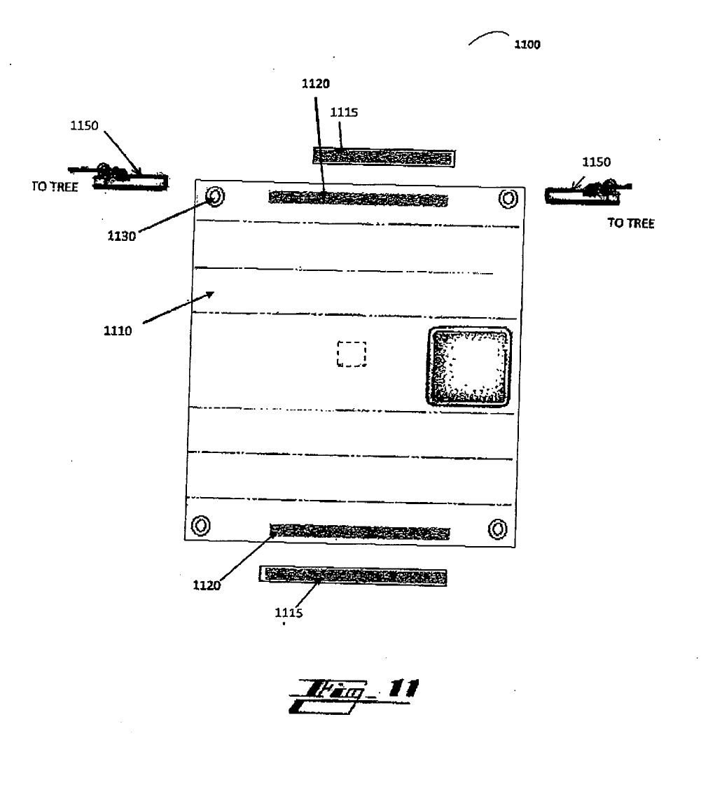

FIG. 13 demonstrates a framed playpen or storage arrangement. 1310 the comfort pad arrangement is shown. 1320 is an assembly view of a nonlimiting example of an expanded playpen or storage frame. Detail 1330, typical in 8 places is a nonlimiting example showing a reinforced clearance hole, used to secure the pad to the frame. Detail 1340 is the ground anchor attachment point shown as detail 1050 in FIG. 10. 1350 is typical in 4 places and is shown as a rope attachment or other attachment means and is secured to the arrangement on one end, and the other end of the rope is attached to a vertical structure such as a tree. 1360 shows the final assembly with the pad located over the frame, leaving a cavity/open area for the child or possessions. The assembly is open from above. The assembly can also be covered with the inner liner, once removed from the outer liner.

FIG. 14 demonstrates a non limiting example of a bottle retainer to facilitate use of the invention as a water collection device. The 1410 pad has attachment location for the 1430 tube with 1440 elastic ring inserted there through. A 1450 bottle is attached by folding the corner behind the bottle as the bottle is inserted to the 1440 elastic ring. The result thereof is that water that travels to the corner of the pad, along its outer surface is routed to the corner and then flows into the retained bottle.

With the number of arrangements, it is an objective of the invention to be user friendly. To that end, it is contemplated that labels, colored dots, or other coordinating details will be used to identify related sections of the apparatus, according to the particular arrangement.

In general, it is appreciated that a backpack has been described as an exemplary embodiment. It is understood that other types of carrying packs are contemplated, including, but not limited to messenger bags, “man-bags” and other dual or single strap bags.

It is further appreciated that the folding pattern of the comfort pad has been described in a specific folding pattern for illustrative purposes only. It is appreciated that other folding patterns are contemplated.

In an embodiment, the apparatus is a pad. The structure necessary includes resilient outer and personable inner layers. Personable includes a softness to the touch, an insulating capability, is washable, and generally is appropriate fabric for contact with the user's clothes or skin. The structure further includes a pillow. The details include attachment details along the outer edge to allow connection of multiple pads into a larger pad, or to facilitate a small social community. Details include fastening details along the perimeter of the two liners that allow removal of the inner liner for use separately from the outer liner.

I claim:

1. A versatile apparatus arranged as a carrying pack is disclosed to convert to each arrangement of a comfort pad, and a hooded garment and
the carrying pack with a substantially hollow interior, Shoulder straps, At least one closure strap, A front flap and rear flap as part of the planar pad, Removably secured together, to form a lid to cover the interior of pack; At least a first and a second side flap connected to the front flap and removably secured to rear flap and First and second side flaps function as side wall of carrying pack and
when completely unfolded to the comfort pad arrangement the carrying pack has an inner and an outer planar pad attached to one another, and
attachment details, such that two or more comfort pads can be attached to form a much larger comfort pad.

2. The versatile apparatus of claim 1 having poncho structure and details including a Hood disposed between upper and lower surface and concealed with a zipper, a cinching cord to secure the hood to a user, connectors such as snaps to form a sleeve area for a user's arms, and having a waterproof or water resistant exterior fabric, and further having an insulating lining for the interior surface.

3. The versatile apparatus of claim 1 having appropriate coloration, structure and details to suspend the comfort pad in a vertical orientation as a wall or hunting blind.

4. The versatile apparatus of claim 1 having a tent arrangement comprising the apparatus and tent poles, the tent poles sized and fashioned to fit in to retention details on the apparatus, said tent poles and apparatus forming a structure with a triangular cross section, and having fabric edges with attachment means to create an enclosed tent structure, and further the apparatus having attachment details that connect two of the apparati to additionally form a floored tent;
furthermore, the tent arrangement having attachment details on opposite ends that connect with at least one additional tent arrangement and, the apparatus pad having reinforced fabric structure to physically support the tent embodiment.

5. The versatile apparatus of claim 1 having water collection details including tubes and bottle attachment means that funnel and capture water from the surface of the apparatus pad while it is being worn as a poncho, further including structural elements such as rods which support the apparatus pad in an flat manner to optimize rain catching capability to funnel and capture a higher amount of water.

6. The versatile apparatus of claim 1 having removable structural elements such as rods and rigid planar inserts that are assembled to form a hammock, the apparatus pad includes an arrangement of fasteners to secure it to the hammock structural elements and form a fabric surface to support a user;
further, the frame and apparatus pad have grommets and attachment points suitable for suspending the chair from external vertical structures such as posts and trees, furthermore, the hammock arrangement having attachment details on opposite ends that connect with at least one additional hammock arrangement and, the apparatus pad having reinforced fabric structure to physically support the hammock embodiment.

7. The versatile apparatus of claim 1 having removable structural elements such as a collapsible chair frame assembly or rods and rigid planar inserts that are assembled to form a chair frame with quick connect attachments and at least 3 legs;
the apparatus pad includes an arrangement of fasteners to secure it to the chair frame and form a fabric surface to support a user;
further, in an embodiment, the frame and apparatus pad have grommets and attachment points suitable for suspending the chair from external vertical structures such as posts and trees, including a bottom tether point that facilitates a rope and anchor; furthermore, the apparatus pad in a suspended state does not require the use of the frame structure to function as a seat;
the versatile apparatus further having attachment means on opposite sides such that two or more chairs can be connected and,
the apparatus pad having reinforced fabric structure to physically support the chair embodiment.

8. The versatile apparatus of claim 1 having removable structural elements such as rods and rigid planar inserts to form a frame with quick connect attachments, the apparatus pad having attachment elements that secure it to the frame in the form of a playpen for at least one small child, having at least 3 enclosed sides, an enclosed bottom and an open top, that form a playpen for a small child;
the frame having at least 4 structural elements that extend beyond the bottom of the playpen to keep it elevated above the ground, the apparatus having an arrangement of fasteners to secure an included breathable and protective cover such as mesh fabric;
further, the playpen arrangement having attachment details on opposite ends that connect with at least one additional playpen arrangement
further, in an embodiment, the frame and playpen have grommets and attachment points suitable for suspending the playpen from external vertical structures such as posts or trees and, the apparatus pad having reinforced fabric structure to physically support the playpen embodiment.

9. The versatile apparatus of claim 1 having removable structural elements such as rods and rigid planar inserts to maintain its shape and strap geometry to accomplish more professional looks and to secure the apparatus to a bicycle, luggage rack, motorcycle attachment;
and in an nonlimiting embodiment a separable computer bag is included, in another nonlimiting embodiment soft fabric bags are provided to hold delicate items such as shoes; and
in a nonlimiting embodiment a briefcase is included and provides removable structural elements.

10. The apparatus of claim 1 having details and structure to contain garments and protect their shape and condition, structure includes sleeves and rods to hold and protect a garment and details include attachment points integrated into the interior of the pack.

11. The apparatus of claim 1 having an additional liner made of Mylar or similar resilient, lightweight material that is removable to form an alternative to using the full apparatus pad as a covering usable in alternate arrangements.

12. Method for converting between a backpack, to comfort pad, to poncho, to water collection device, to tent, to hammock, to seat, to playpen, to office pack comprising using nonlimiting attachments means including ropes tied to reinforced clearance holes and loops, further, attachment means are sometimes unique to a particular arrangement and are color coded or otherwise marked to coordinate the attachment points for each particular arrangement:
START:
Apparatus is in the backpack arrangement and various framing assemblies for the various arrangements are available and are located inside the backpack as needed,
Open Velcro side flap
Open Velcro
Release Clip
Release Clip
Unfold y axis x 2
Unfold x axis*2+2 additional sub unfolds
Remove contents including pillow,
User has functional comfort pad or mat;
Alternately remove inner liner from outer liner using perimeter securing means, inner liner can be mylar or breathable fabric,
User has two generally planar, flexible panels for use, and as components of other disclosed arrangements,
Secure mat together with a second mat by mating male fasteners along a left side of the first mat to female fasteners along a right side of the second mat,
User has a large mat,
Return to single mat arrangement;
Beginning with a single mat, open 1 hood by releasing fastening means that secures and closes the hood detail,
Fold mat in half along the x axis,
Snap underarm attachments to form sleeve sections,
User has a wearable, hooded poncho,
Attach bottle to corner attachment details to collect rain water,
User has wearable, poncho water collection arrangement,
Alternately, get and assemble frame for water collection arrangement,
Place poncho assembly over water collection frame,
Secure poncho to the water collection frame using integrated attachments on the poncho,
Attach bottle to corner details to collect rain water,
User has optimized water collection arrangement;
Return assembly to the single mat arrangement;
Get and assemble tent frame rods into a tent frame,
Place mat atop the tent frame, using corner post receiver pockets insert tent frame ends into mat corner receiver pockets,
Secure mat to frame upper rod using integrated snaps,
User has tent,
Alternatively insert frame between inner and outer liner of mat for quick construction,
Abut and connect second tent frame and mat assembly using male fasteners on one tent secured to female fasteners on second tent,
User has large tent,
Return assembly to the single mat arrangement;
Remove and assemble seat frame components to form a seat frame,
Place mat over chair frame and secure integrated snaps to securely cover the seat frame.
User has a chair,
Using 2 chair upper corner attachment details secure one end of a rope to the mat and chair frame, leaving 2 loose ends,
Secure loose ends of 2 ropes to external vertical supports to create a suspended chair,
Secure an additional rope to the ground anchoring detail on the underside of the mat, leaving 1 loose end,
Secure the loose end of additional rope to a ground anchor,
Screw the ground anchor into the ground to stabilize the suspended chair,
Return assembly to the single mat arrangement;
Secure 4 ropes to attachment details at each corner of the mat, leaving 4 loose ends;
Secure the loose ends of 4 ropes to 4 external vertical support structures,
Secure an additional rope to the ground anchoring detail on the underside of the mat, leaving 1 loose end,
Secure loose end of additional rope to a ground anchor,
Secure the ground anchor into the ground to stabilize the hammock,
User has a hammock secured and ready to use;
Return assembly to the single mat arrangement;
Remove inner liner of mat from outer liner of mat,
Remove and assemble playpen frame components to form a playpen frame,
Place outer layer of mat over playpen frame and secure integrated fasteners to securely cover the playpen frame,
Place inner layer over the playpen assembly and secure ends of inner layer to the open end of the playpen to form a bug and debris guard,
User has a playpen,
Alternately user has a storage container;
Using 4 playpen upper corner attachment details secure one end of a rope to the mat and playpen frame, leaving 4 loose ends,
Secure loose ends of 4 ropes to external vertical supports,
Secure an additional rope to the ground anchoring detail on the underside of the mat, leaving 1 loose end,
Secure the loose end of additional rope to a ground anchor,
Screw the ground anchor into the ground to stabilize the suspended playpen,
User has a securely suspended playpen,
Alternately, user has an elevated storage container,
Secure playpen arrangement to a second playpen arrangement by mating male fasteners along a left side of the first playpen to female fasteners along a right side of the second playpen,
User has a large playpen or large storage container,
Alternately, User has large playpen or large storage container,
Return to single mat arrangement;
Return assembly to the single mat arrangement;
Secure 2 ropes to attachment details at two adjacent corners leaving 2 loose ends,
Secure the loose ends of 2 ropes to 2 external vertical support structures,
User has a curtain wall or blind,
Return assembly to the single mat arrangement;
Return assembly to the backpack arrangement;
Get and assemble office pack framing components,
Insert office pack frame into backpack,
Insert dress shoe fabric bag into office pack,
Alternately, insert computer bag into office pack,
Alternately, insert custom fit briefcase into backpack,
User has office pack in either of three arrangements;
Secure office pack to package shelf using the office pack tether rings;
USER HAS A FUNCTIONAL LARGE MAT
Unzip hood
Insert to body
Snap sides to enclose
USER HAS A FUNCTIONAL PONCHO
Remove structural members, extend and secure collapsible rods, insert members and rods to reinforced pockets on the mat apparatus,
Remove ropes and or straps with connection details
Attach ropes and any straps to corners, 4 recommended but 3 are still effective.
Attach to trees or other vertical supports
USER HAS A FUNCTIONAL HAMMOCK OR SEAT
END
The disclosed apparatus incorporates the above description as a base form, and adds the necessary structure and details to enable the embodiments herein disclosed. The disclosed apparatus also incorporates the above method but adds to it the assembly of additional structural components and attachments. For example, to execute the tent embodiment, the frame must be assembled by extending and securely seating collapsible rods together, then inserting them to pockets, and covering the frame with the apparatus mat.
Although a very narrow description is presented herein, it should be recognized that the scope of this invention is much broader than presented by the claim. It is intended that broader claims will be submitted and in an application that claims the benefit of priority from this application.
The following statement summarizes certain aspects of the invention described in this provisional specification. They are not claims in the sense of 35 USC 112:
a) An apparatus consisting of a planar mat, structure and details to provide a versatile system that is useful as a mat, a backpack, a poncho, a hammock or seat and other embodiments as disclosed.
